(19) United States
(12) Patent Application Publication
(10) Pub. No.: US 2021/0364480 A1
(43) Pub. Date: Nov. 25, 2021

(54) Systems and Methods for Ultrasonic Inspection

(71) Applicant: United States Department of Energy, Washington, DC (US)

(72) Inventors: Charles Keith Sword, Irwin, PA (US); David August Driggers, Irwin, PA (US)

(73) Assignee: United States Department of Energy, Washington, DC (US)

(21) Appl. No.: 17/134,693

(22) Filed: Dec. 28, 2020

Related U.S. Application Data
(60) Provisional application No. 63/028,822, filed on May 22, 2020.

(51) Int. Cl. G01N 29/265; G01N 29/24; G01N 29/06; G01N 29/22

(52) U.S. Cl. CPC G01N 29/265; G01N 29/2437; G01N 29/0654; G01N 2291/101; G01N 2291/0289; G01N 2291/023; G01N 29/225

(57) ABSTRACT

Disclosed is a scanning system including a mechanism base; a carriage, with a first carriage side attached to a first base side and a second carriage side connected to a drive mechanism, wherein the carriage is configured to move the mechanism base; a probe associated with the carriage, the probe having a first side and a second side; an actuator assembly including an actuator and a housing having a first side and a second side, wherein a first housing side is connected to the actuator and a second housing side is connected to the carriage; and an adjustable mount having a first side and a second side, wherein a first mount side is attached to the second housing side and the second mount side is attached to the first probe side, wherein the actuator assembly is configured to maintain the second probe side in a constant contact with an object.

### CLAIM TO PRIORITY

This application claims priority to U.S. Provisional Patent Application Ser. No. 63/028,822, filed May 22, 2020, the entirety of which is herein incorporated by reference.

### NOTICE OF GOVERNMENT RIGHTS

The United States Government has rights in this application and any resultant patents claiming priority to this application pursuant to contract DE-NR0000031 between the United States Department of Energy and Bechtel Marine Propulsion Corporation Knolls Atomic Power Laboratory.

### FIELD

The present subject matter relates generally to acoustic measurement. In particular, the present subject matter relates to ultrasonic measurement.

### BACKGROUND

Accurate acoustic measurements require a medium consistently coupling a signal into an object to be measured, and coupling a signal received from the measured object into a probe. A layer of material can be used that is acoustically compatible at the sound frequency being used by existing scanning systems to transmit sound from one medium into another. This coupling medium is typically either water or gel and small amounts can be pumped continuously under the probe during inspection. Coupling consistency is affected by the consistency of probe contact with the object. Variation in probe contact force with the object causes variation in the thickness and impedance of the coupling medium and, as a result, variation in the quality of the received signal.

Often the surface contour of the object to be measured and mounting arrangement of existing scanning systems cause the spacing between a probe mount mechanism and component surface to vary. Some probes use springs to provide consistent probe-to-object coupling. Since spring force is proportional to displacement, spacing variations, such as geometric changes in the surface of the component being inspected, cause variations in probe contact force, which in turn cause variations in probe-to-component coupling. To compensate for these variations, contact force is adjusted to maintain consistent coupling using heavier or shorter springs and mechanically adjusting the distance of the probe mounting mechanism from the surface of the component. If the coupling medium requires more (or less) contact force to be effective to maintain sufficient contact between the probe and the object surface, it is often necessary to replace the springs with a heavier/shorter or lighter/longer spring. This requires physically compressing the spring and holding it against the tension while changing probe hardware, a time-consuming and labor-intensive operation.

### SUMMARY

Disclosed is a scanning system configured to scan an object. The scanning system includes a mechanism base, the mechanism base having a first base side and a second base side; a carriage having a first carriage side and a second carriage side, with the first carriage side attached to the first base side and the second carriage side connected to a drive mechanism, the carriage being configured to move the mechanism base in a first axial direction; a probe operably connected with the carriage, the probe having a first probe side and a second probe side; an actuator assembly including an actuator and a housing having a first housing side and a second housing side, the first housing side being connected to the actuator and the second housing side is connected to the carriage; and an adjustable mount having a first mount side and a second mount side, the first mount side being attached to the second housing side and the second mount side being attached to the first probe side, wherein the actuator assembly is configured to maintain the second probe side in a constant contact with said object.

In certain exemplary embodiments the actuator includes a cylinder, a piston, and a rod\ having a first end and a second end. The first end of the rod is attached to the piston and the second end of the rod is attached to the carriage, and the rod is configured to move vertically with respect to the cylinder. In other exemplary embodiments the actuator includes a parallelpiped structure connected to a cylinder, a piston, and a rod having a first end and a second end. The first end of the rod is operably connected with the piston, the second end of the rod is attached to the carriage, and the rod is configured to move with respect to the cylinder.

Also disclosed is an exemplary method for inspecting an object using a scanner system having a probe connected to an adjustable mount operably connect with an actuator configured to maintain the probe in a constant contact force with the object, the method including the steps of moving the probe along the object; maintaining the probe in a constant contact force with the object; generating a signal representative of a position of the probe on the object; emitting a pulse into the object; and receiving a pulse reflected from the object.

Still another exemplary embodiment includes a computer program product including a non-transitory computer readable medium having stored thereon computer executable instructions that when executed cause the computer to perform a method for inspecting an object using a scanner system having a probe connected to an adjustable mount operably connected with an actuator configured to maintain the probe in a constant contact force with the object, the method including the steps of moving the probe along the object; maintaining the probe in a constant contact force with the object; generating a signal representative of a position of the probe on the object; emitting a pulse into the object; and receiving a pulse reflected from the object.

### BRIEF DESCRIPTION OF THE DRAWINGS

A description of the present subject matter including various embodiments thereof is presented with reference to the accompanying drawings, the description not meaning to be considered limiting in any matter, wherein:

FIG. 1 illustrates an isometric view of a first exemplary embodiment of a scanning system;

FIG. 2 illustrates a side view of a first exemplary embodiment of a scanning system;

FIG. 3 illustrates a front view of a first exemplary embodiment of a scanning system;

FIG. 4 illustrates a partial view of an first exemplary embodiment of an actuator assembly;

FIG. 5 illustrates an isometric view of a second exemplary embodiment of a scanning system;

FIG. 6 illustrates a side view of a second exemplary embodiment of a scanning system;

FIG. 7 illustrates a partial view of an second exemplary embodiment of an actuator assembly; and

FIG. 8 illustrates a diagram of an exemplary method of scanning an object.

Similar reference numerals and designators in the various figures refer to like elements.

### DETAILED DESCRIPTION

Throughout the discussion below, use of the terms “about” and “approximately” are used to indicate engineering tolerances which would be well understood by a person of ordinary skill in the art for any particular application or embodiment. Further, while an order of the method steps is provided, this order is exemplary only; as will be recognized by those of skill in the art, the order of the method steps may be varied without impacting the overall efficacy of the method.

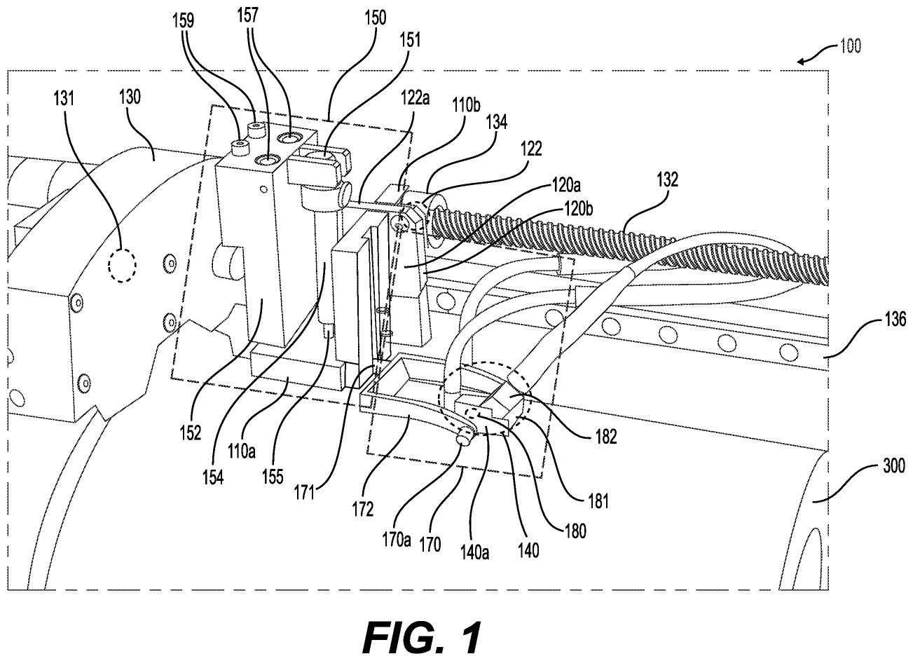

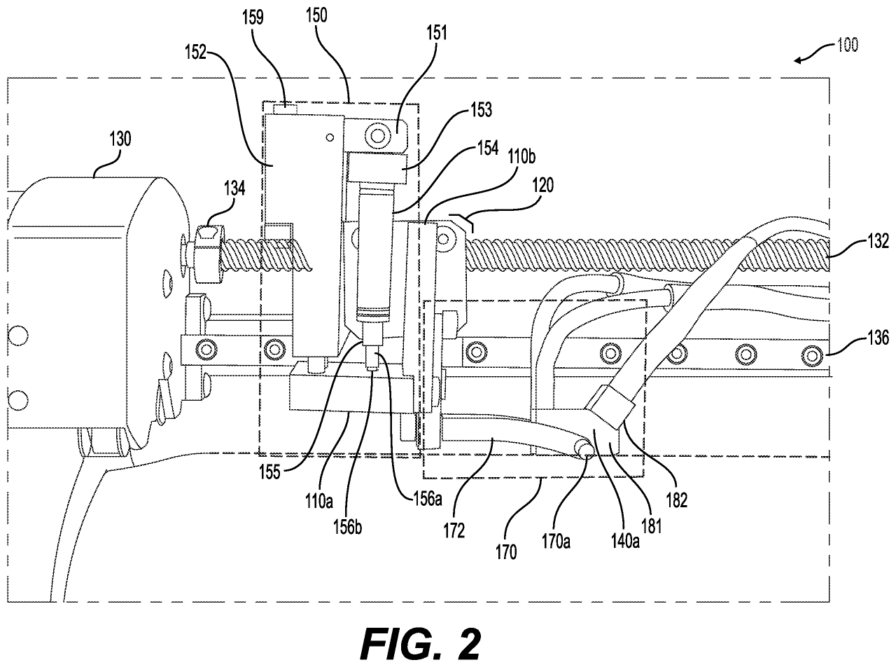

FIGS. 1-4 illustrate a first exemplary embodiment of a scanning system 100 configured to scan an object 300. This exemplary embodiment includes a mechanism base 110, with the mechanism base 110 having a mechanism base first side 110a and a mechanism base second side 110b. The scanning system 100 further includes a carriage 120 having a carriage first side 120a and a carriage second side 120b, with the carriage first side 120a attached to the mechanism base first side 110a and the carriage second side 120b connected to a drive mechanism 130. In the exemplary embodiment shown carriage 120 is configured to move mechanism base 110 in a first axial direction, although in other embodiments carriage 120 can also be configured to move mechanism base 110 in other directions to accommodate variations in object 300, such as to accommodate different in situ installation orientations.

The exemplary embodiment of FIGS. 1-4 further includes a probe 140 operably connected with carriage 120, with probe 140 having a first probe side 140a and a second probe side 140b. The probe may be any type of probe known in the art capable of performing non-destructive inspection of object 300. In some embodiments, probe 140 transmits an ultrasonic pulse into the component under inspection at a specific transmission frequency and angle. In certain embodiments, the probe 140 includes a piezoelectric element 181 that can be custom shaped to conform to the shape of the object to be measured 300. In certain embodiments, the probe 140 piezoelectric element 181 includes a piezoelectric crystal (not shown) connected to a plastic shoe or wedge (not shown), which in certain exemplary embodiments is custom shaped to conform to the shape of the object to be measured 300. In one implementation, the ultrasonic pulse is generated from the electrical excitation of the piezoelectric crystal located inside the body of the probe 140 which is generated by ultrasonic inspection instrument as would be understood by one of ordinary skill in the art. The sound pulse (frequency and amplitude) generated depends on the shape of the piezoelectric crystal and electrical excitation applied by the ultrasonic inspection instrument. The direction of the ultrasonic pulse is dependent on the angle of the piezoelectric element 181 or, in certain implementations, the angle of the wedge and subsequent refraction angle into the part which is dictated by a sound velocity relationship identified by Snells Law.

The exemplary embodiment of FIGS. 1-4 further includes a vertical actuator assembly 150 including an actuator 151 and a housing 152 having a housing first side 152a and a housing second side 152b, wherein the housing first side 152a is connected to the actuator 151 and the housing second side 152b is connected to carriage 120. The embodiment shown further includes an adjustable mount 170 having an extension arm 171 connecting mechanism base second side 110b and mount 170, with mount first side 170a and a mount second side 170b connecting to probe first side 140a and probe second side 140b respectively, with the vertical actuator assembly 150 configured to maintain the probe 140 in a constant contact force with an object to be measured 300. In the exemplary scanning system of FIGS. 1-4, carriage 120 further includes a carriage plate 122 which has a carriage plate first side 122a and a carriage plate second side 122b, with the carriage plate first side 122a connected to carriage second side 120b, and drive mechanism 130 connected to the carriage plate second side 122b. In the embodiment shown, drive mechanism 130 includes a drive rod 132 connected to the drive mechanism 130 and the carriage plate second side 122b, and is configured to move carriage 120 in a first scanning direction. In the exemplary embodiment shown, drive mechanism 130 includes a bushing 134 at least partially encompassing a guide 136, with the bushing configured to move guide 136 through bushing 134. In still other embodiments, the scanning system 100 is arranged using linkages to scan in either a circumferential motion around the component and/or in an axial direction along the length of the component.

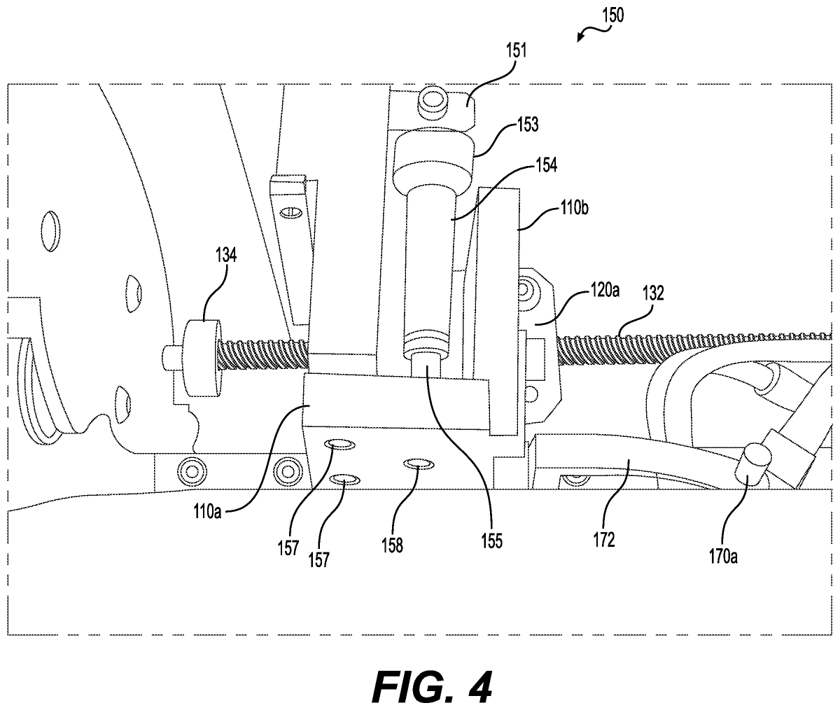

FIG. 4 illustrates a partial view of a first exemplary embodiment of an actuator assembly 150. As shown in FIG. 4, vertical actuator assembly 150 includes an actuator 151, which further includes a cylinder 154, a piston 155. In the embodiment shown, a pressure regulator 153 is operably connected with the actuator 151, with actuator 151 operably connected to a fluid source (not shown). In certain embodiments the fluid is pneumatic, while in other embodiments the fluid is hydraulic. Pressure applied to actuator 151 moves mechanism base first side 110a toward the surface of the object to be measured 300. Traversal direction of motion of carriage 120 is controlled by guides 159 in housing 152. As carriage 120 and mechanism base first side 110a move, probe 140 moves to contact the surface of the object 300. Thus, as the actuator assembly 150 is activated, the probe 140 can be moved vertically over changes in the surface of the object to be measured 300 while it is being moved in accordance with the shape of the object to be measured 300 (i.e. both transversely and circumferentially for a pipe).

In the embodiment shown in FIGS. 1-4, rod 156 is configured to move vertically with respect to cylinder 154. Rod 156 has a rod first end 156a and a rod second end 156b, with the rod first end 156a attaching to piston 155 and rod second end 156b attaching to mechanism first base side 110a. In the exemplary embodiment shown, actuator 151 drives mechanism base second side 110a vertically down relative to the object to be measured 300. Applied force is increased or decreased using pressure regulator 153, such that contact pressure of probe 140 on the surface of object to be measured 300 is maintained and is independent of vertical displacement as probe 140 is scanned over a non-flat surface.

The force applied to the probe 140 is proportional to the pressure applied to the actuator 151. By altering the pressure applied, the compliance (stiffness) can be adjusted to allow slight amounts of vertical movement by the probe 140, which allows for better adaption over a rough surface such as the object to be measured 300. The vertical movement occurs while the probe 140 is being traversed over the surface of the object to be measured 300 in a specific pattern. The pattern can be developed based on the orientation of defect(s) to be identified as the ultrasonic inspection is largely direction depended (i.e. sound travels in specific directions). The applied pressure can be selected to provide a softer or rougher ride over the surface. Smoother movement of the probe 140 over the object to be measure 300 results in the generation of better inspection data. Pressure applied by the actuator 153 is directed approximately normal to the surface of the object to be measured 300. Hence, a majority of the pressure is directed into contact force from probe 140 onto the surface of the object to be measured 300.

In the exemplary embodiment shown in FIGS. 1-4, the magnitude of the probe 140 contact force is controlled by pressure regulator 153. Since pressure applied to the actuator 151 is regulated, contact force of the probe on the surface of the object to be measured 300 is maintained constant by pressure regulator 153, even when the probe moves up or down with variations in the surface contours of the object to be measured 300. Thus the probe contact force can easily be adjusted by adjusting the pressure regulator 153. In one example, probe 140 contact force is proportional to the pressure applied by regulator 153. In certain embodiments when the pressure is released one or more internal actuator return springs 157 retract probe 140 from the surface of the object to be measured 300. In one example, the pressure can be released by adjusting or closing a valve, such as a ball valve, operably connected to the pressure regulator 153. In certain embodiments, actuator 151 range of motion is limited to approximately 0.5 inches for inspection applications. In other exemplary embodiments with greater ranges of motion, the sensor assembly 100 optionally includes stops (not shown) in carriage 120 and/or mechanism base 110 to prevent vertical ejection of carriage 120. The stops prevent inadvertent damage to the scanning assembly 100 if a programming error in the motion control occurred or if there was a failure of an encoder. Under certain circumstances the scanning assembly 100 could have an error causing unexpected motion which could prevent parts from running together and lead to damage.

In certain embodiments, actuator housing second side 152b is connected to the carriage 120 by a floating pivot pin 158 embedded in the actuator assembly 150. Pivot pin 158 helps preclude binding of cylinder 154 caused by a misalignment of mechanism base 110 and carriage 120. Thus, this allows for some flexibility in the system during movement over an irregular surface thereby preventing parts from jamming together. In the exemplary embodiment of FIGS. 1-4, pivot pin 158 connects on a pivot pin first end 158a to the actuator rod second end 156b and connects on the pivot pin second end 158b to mechanism base first side 110a. In certain exemplary actuator assemblies having pivot pin 158, at least a portion of the actuator assembly 150 is fabricated using additive manufacturing. In certain exemplary embodiments this can be done by direct to metal additive manufacturing to print pin 158 completely internal to actuator assembly 150, such that pin 158 floats independently from the body of carriage 120. The independent floating provides another degree of freedom to the scanning system 100 that makes the actuator 151 performance better. Thus, the overall scanning system 100 can provide more compliance to uneven surfaces and smoother movement of the probe 140.

In the exemplary embodiment shown in FIGS. 1-4, scanning system 100 includes an adjustable mount 170, wherein the adjustable mount second side 170b has an extension arm 171 and a fork 172. In the exemplary embodiment shown, a transceiver 180 is connected to fork 172. Transceiver 180 is configured to emit a pulse (not shown) into an object to be measured (not shown), and is also configured to receive a pulse reflected from the object to be measured. Certain exemplary embodiments may also include a position indicator 131 located within drive mechanism 130 and configured to record a position of the transceiver 180. Position indicator 131 may be any type of position indicator known in the art, such as a laser-based grid detection system, sensors with a designated reference point on the object, an encoder or the like. In the exemplary embodiment shown, transceiver 180 includes a piezoelectric element 181, with transceiver 180 configured to convert at least one received reflected pulse into a digital signal.

In certain embodiments an ultrasound pulse is directed into the object to be measured, and a pulse reflected from the surfaces of internal discontinuities in the object is received by transceiver 180. In these embodiments, at least a portion of the reflected energy propagates back into probe 140 where piezoelectric element 181 converts the received reflected energy into electrical energy that is converted into a digital signal through an analog-to-digital converter (not shown). Inspection is performed by scanning probe 140 over the surface of the object to be measured and capturing these digital signals into a computer memory. In certain exemplary embodiments, position indicator 131 records a position of probe 140 and correlates the probe position on the object to be measured with at least one received reflected pulse. In certain exemplary embodiments this is done by mounting providing encoded position data to a computer memory (not shown). In certain embodiments the stored signal and position data are used to create data images that show position correlations used to discriminate flawed components from normal components. In other embodiments, assessment (discrimination) is done though operator interpretation of the data image for abnormalities utilizing computers and software. Operators are trained to make this interpretation through training on equivalent data images obtained from intentionally flawed components though the development phase of an inspection program.

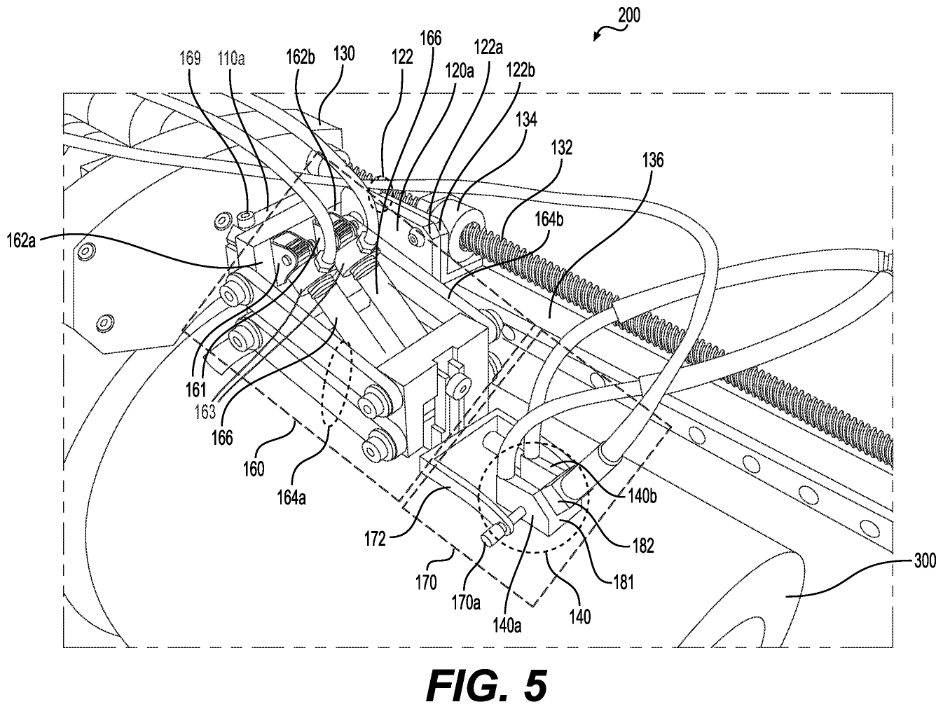

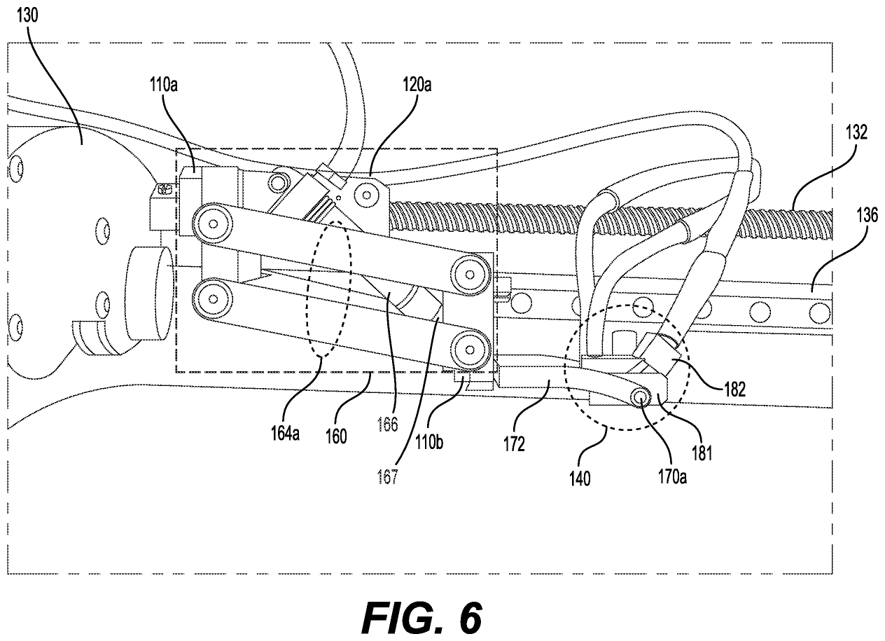

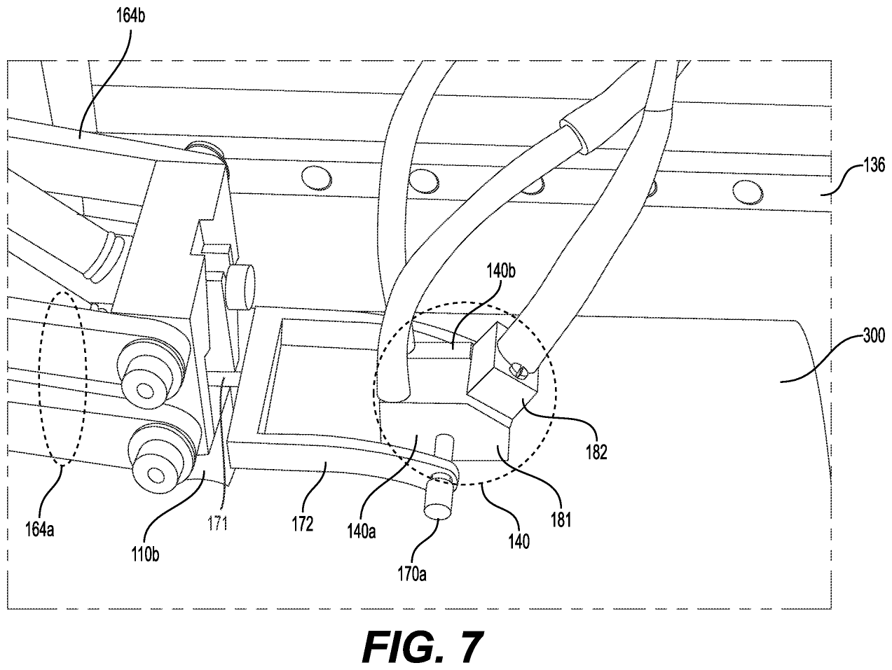

FIGS. 5-7 illustrate a second exemplary embodiment of a parallelpiped scanning system 200. This exemplary embodiment includes a mechanism base 110, with mechanism base 110 having a mechanism base first side 110a and a mechanism second base side 110b. The system further includes a carriage 120 having a carriage first side 120a and a carriage second side 120b, with the carriage first side 120a attached to the mechanism base first side 110a and the carriage second side 120b connected to a drive mechanism 130. In the exemplary embodiment shown, carriage 120 is configured to move mechanism base 110 in a first axial direction, although in other embodiments carriage 120 can be configured to move mechanism base 110 in other directions.

The exemplary embodiment shown further includes a probe 140 in operable connection with carriage 120, with probe 140 having a first probe side 140a and a second probe side 140b. Probe 140 transmits an ultrasonic sound pulse into the object to be measured 300 at a specific transmission frequency and angle. In certain embodiments, the probe 140 includes a piezoelectric element 181 and a position indicator 131. In certain embodiments, the piezoelectric element 181 is custom shaped to conform to the shape of the object to be measured 300.

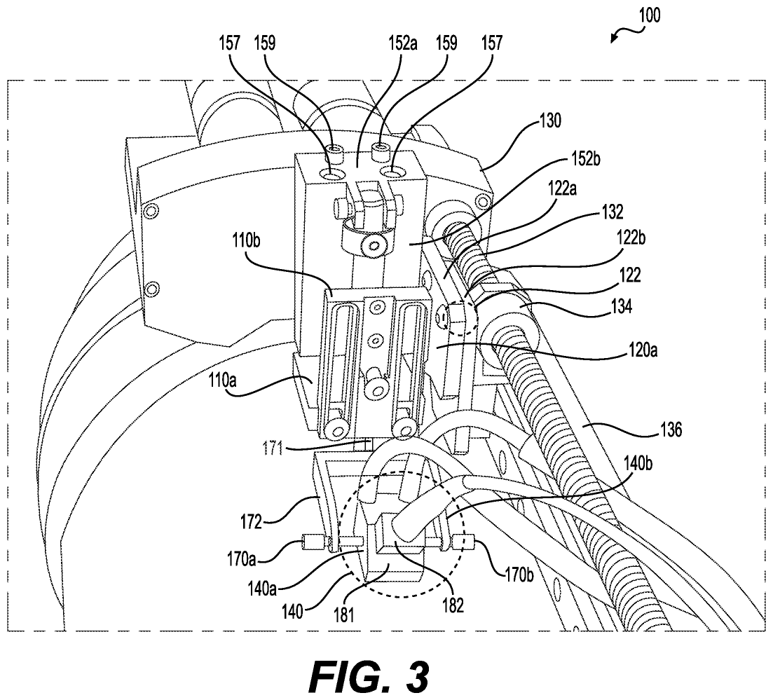

The exemplary embodiment further includes an actuator assembly 160 having an actuator 161 and a housing 162 having a first housing side 162a and a second housing side 162b, wherein the first housing side 162a is connected to actuator 161 and the second housing side 162b is connected to carriage 120. The embodiment shown further includes an adjustable mount 170 having an extension arm 171 connecting housing second side 162b and mount 170, with mount first side 170a and a mount second side 170b (see FIG. 3) connecting to probe first side 140a and probe second side 140b, respectively, with the vertical actuator assembly 160 configured to maintain the probe 140 in a constant contact force with an object to be measured 300.

In the exemplary scanning system of FIGS. 5-7, shown, carriage plate 122 has a carriage plate first side 122a and a carriage plate second plate side 122b, with the carriage plate first side 122a connected to the carriage second side 120b, and the drive mechanism 130 connected to carriage plate second plate side 122b. In the embodiment shown, drive mechanism 130 includes a drive rod 132 connected to the drive mechanism 130 and the carriage plate second side 122b, and is configured to move the carriage 120 in a first scanning direction. In the exemplary embodiment shown, drive mechanism 130 includes a bushing 134 at least partially encompassing a guide 136, with the busing configured to move guide 136 through the bushing 134.

The second exemplary embodiment includes a parallelpiped actuator assembly 160. Compared with actuator embodiments using springs to maintain pressure on probe 140, parallelepiped embodiments have a greater effective measurement length. In the exemplary embodiments shown, pressure applied to actuator 161 moves mechanism base 110b toward the surface of the object 300. Traversal direction of motion of carriage 120 is controlled by guides 169 in mechanism base 110. As carriage 120 and mechanism base 110 moves, probe 140 moves to contact the surface of the object to be measured. In the embodiment shown, probe 140 contact force is proportional to the pressure applied to pressure regulator 163. When the pressure is released, internal actuator return springs retract probe 140 from the surface of the object to be measured 300. In certain embodiments, actuator range of motion is limited to approximately 0.5 inches for inspection applications. In other exemplary embodiments with greater ranges of motion, actuator assembly 160 optionally includes stops (not shown) in carriage 120 and/or mechanism base 110 to prevent vertical ejection of carriage 120.

As shown in FIGS. 5-7, parallelpiped actuator assembly 160 includes an actuator 161 and a housing 162 having a first housing side 162a and a second housing side 162b, and a pressure regulator 163. A compressible fluid such as air or oil would be utilized to generate pressure in actuation cylinders 165. In the exemplary embodiment shown, the compressed fluid is air. Other compressible fluids known to those in the art can be used without departing from the scope of the present subject matter. In the embodiment shown, parallelpiped actuator assembly 160 further includes a parallelpiped structure 164 having a first diagonal assembly 164a and a second diagonal assembly 164b, at least one cylinder 165, a piston 166, and a rod 167. Rod 167 has a rod first end 167a and a rod second end 167b, with rod first end 167a attaching to piston 166 and rod second end 167b attaching to mechanism base second side 110b. In the embodiment shown, rod 167 is configured to move with respect to cylinder 165. Pressure regulator 163 is operably connected with actuator 161, with actuator 161 hydraulically connecting to a fluid source (not shown). In certain embodiments the fluid source is pneumatic, while in other embodiments the fluid source is hydraulic.

In the exemplary embodiment shown, parallelepiped actuator assembly 160 acts through the diagonals 164a/164b, which can be made of the linked section(s), to exert a downward contact force on probe 140 relative to a surface of the object 300. The parallelpiped configuration enables a longer range of motion of the carriage 120 and mechanism base second side 110b and attached probe 140 (as compared with a vertical actuator of similar comparable size). The parallelpiped configuration creates more linear space for longer arms (diagonals), which allows for longer actuators with more travel and a greater range of vertical motion. Having a greater range vertical motion increases the ability to compensate for greater vertical changes (variations) in the surface of the component to be measured, which facilitates the ability to apply a continuous pressure on the probe so that coupling of sound into the part can be maintained despite vertical variations in the surface of the measured component. In certain exemplary embodiments the magnitude of the force applied to probe 140 is adjusted via pressure regulator 163 to maintain a constant contact force on a surface of the object to be measured, even when probe 140 encounters variations in the surface contour of the object to be measured.

Certain exemplary parallelpiped embodiments lose a portion of the vertical probe contact force to a horizontal force component due to the angle of actuator 161 with respect to the vertical (as referenced from a surface of object 300). As one way of compensating for less vertical force translation being applied to the probe 140, the embodiment shown includes at least one additional actuator 161 to compensate for some the force translated horizontally rather than vertically. Other ways of making up for this loss can be used, such as by using a higher pressure source and/or applying a greater initial pressure to the actuator 161 to account for this loss in vertical pressure applied to the surface of the object 300.

In the exemplary embodiment shown, the adjustable mount includes extension arm 171 and a fork 172 with mount first side 170a and mount first side 170b. In the exemplary embodiment shown, a transceiver 180 is connected to fork 172. Transceiver 180 is configured to emit a pulse (not shown) into the object to be measured 300 and is also configured to receive a pulse reflected from the object to be measured 300. Certain exemplary embodiments may also include a position indicator 131 configured to record a position of the transceiver 180. In the exemplary embodiment shown, transceiver 180 includes a piezoelectric element 181, with transceiver 180 configured to convert at least one received reflected pulse into a digital signal.

In certain embodiments an ultrasound pulse is directed into the object to be measured 300, and a pulse reflected from the surfaces of internal discontinuities in the object is received by transceiver 180. In these embodiments, at least a portion of the reflected energy propagates back into probe 140 where piezoelectric element 181 converts the received reflected energy into electrical energy that is converted into a digital signal through an analog-to-digital converter (not shown). Inspection is performed by probe 140 over the surface of the object to be measured 300 and the digital signals are stored in a computer memory (not shown). In certain exemplary embodiments, position indicator 131 records a position of probe 140 and correlates the probe 140 position on the object to be measured 300 with at least one received reflected pulse (not shown). In certain exemplary embodiments this is done by providing encoded position data to the computer memory. In certain embodiments the stored signal and position data are used to create data images that show position correlations used to discriminate flawed components from normal components. In other embodiments, assessment (discrimination) is done though operator interpretation of the data image for abnormalities utilizing computers and software. Operators are trained to make this interpretation through training on equivalent data images obtained from intentionally flawed components though the development phase of an inspection program.

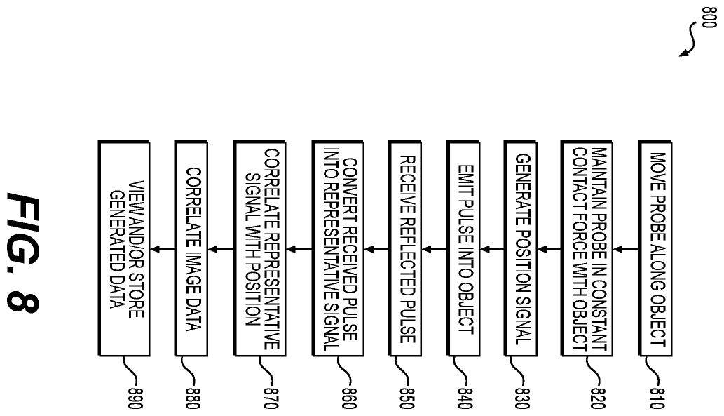

FIG. 8 illustrates an exemplary method 800 for inspecting an object 300 using a scanner system such as systems 100/200 having probe 140 connected to an adjustable mount 170 operably connected with an actuator 151/161 configured to maintain probe 140 in a constant contact force with the object 300. In certain exemplary methods, probe 140 is pneumatically maintained in a constant contact force with the object. In certain other exemplary methods, probe 140 is hydraulically maintained in a constant contact force with the object. The exemplary method 800 includes moving the probe along the object (step 810), maintaining the probe in a constant contact force with the surface of object 300 (step 820), generating a signal representative of a position of the probe on object 300 (step 830), emitting a pulse into object 300 (step 840), receiving a pulse reflected from the object 300 (step 850), converting at least one received pulse into a signal representative of the measured portion of object 300 (step 860), and correlating that representative signal with a probe position (step 870). Certain exemplary methods further include generating a signal representative of an image of at least a portion of object 300 (step 880), and viewing the resulting position-based inspection data on a display (not shown) and/or storing the data for later use (step 890). These steps can be repeated to generate a representative image of any portion of the object to be measured. Further, the steps may be implemented manually or by a special-purpose computer having processing circuitry and programming instructions stored thereon which when executed by the computer cause the computer to perform the steps of FIG. 8 utilizing inputs such as the position of the probe from the transceiver 180, the position indicator 131 and pulse reflection information which causes the computer to continuously control the actuator 151/161 to drive the scanning system 100/200 accordingly.

Utilizing one or more of the steps illustrated in FIG. 8, the systems 100/200 described herein can scan cylindrical, conical, or flat geometries (i.e. objects) made of materials suitable for ultrasonic inspection including, for example, metals, composites, and some polymeric materials. Such scanning can identify and characterize defects (such as voids, cracks, etc,) internal to the object under inspection. Thus, these inspections can be performed to assess the quality of a component or suitability for continued use. The systems 100/200 can also be configured to support various inspection methods via different probes such as surface eddy current probes or surface wave ultrasonic inspection probes.

### CONCLUSION

It will be understood that many additional changes in the details, materials, steps and arrangement of parts, which have been herein described and illustrated to explain the nature of the subject matter, may be made by those skilled in the art within the principle and scope of the invention as expressed in the appended claims. The steps of the methods described above may be performed in any order unless the order is restricted in the discussion. Any element of any embodiment may be used in any other embodiment and/or substituted for an element of any other embodiment unless specifically restricted in the discussion.

We claim:

1. A scanning system configured to scan an object, comprising:
a mechanism base, the mechanism base having a first base side and a second base side;
a carriage having a first carriage side and a second carriage side, with the first carriage side attached to the first base side and the second carriage side connected to a drive mechanism, wherein the carriage is configured to move the mechanism base in a first axial direction;
a probe operably connected with the carriage, the probe having a first probe side and a second probe side;
an actuator assembly including an actuator and a housing having a first housing side and a second housing side, wherein the first housing side is connected to the actuator and the second housing side is connected to the carriage; and
an adjustable mount having a first mount side and a second mount side, wherein the first mount side is attached to the second side base and the second mount side is attached to the first probe side,
wherein the actuator assembly is configured to maintain the second probe side in a constant contact with said object.

2. The scanning system of claim 1, further comprising:
a carriage plate having a first plate side and a second plate side,
wherein the first plate side is connected to the second carriage side,
wherein the drive mechanism is connected to the second plate side of the carriage plate.

3. The scanning system of claim 2, further comprising:
a drive rod connected to the drive mechanism and the second side of the carriage plate and configured to move the carriage in a first scanning direction.

4. The scanning system of claim 3, further comprising:
a bushing at least partially encompassing a guide and configured to move the guide through the bushing.

5. The scanning system of claim 4, wherein the adjustable mount further includes an extension arm and a fork.

6. The scanning system of claim 5, wherein the second side of the actuator housing is connected to the carriage by a floating pin embedded in the actuator assembly.

7. The scanning system of claim 6, further comprising:
a pressure regulator operably connected with the actuator.

8. The scanning system of claim 7, wherein the actuator is hydraulically connected to a fluid source.

9. The scanning system of claim 8, wherein the fluid is pneumatic.

10. The scanning system of claim 9, further comprising:
a transceiver configured to emit a pulse into the object and to receive a pulse reflected from the object; and
a position indicator configured to record a position of the transceiver.

11. The scanning system of claim 10, wherein the transceiver includes a piezoelectric element.

12. The scanning system of claim 11, wherein the transceiver is configured to convert at least one received reflected pulse into a digital signal.

13. The scanning system of claim 12, wherein
the actuator includes a cylinder, a piston, and a rod, the rod having a first end and a second end,
the first end of the rod is attached to the piston and the second end of the rod is attached to the second base side, and
the rod is configured to move vertically with respect to the cylinder.

14. The scanning system of claim 13, further comprising:
a pivot pin attached to the second end of the rod.

15. The scanning system of claim 12, wherein
the actuator includes a parallelpiped structure connected to a cylinder, a piston, and a rod, the rod having a first end and a second end, the first end of the rod is operably connected with the piston, the second end of the rod is attached to the second base side, and
the rod is configured to move with respect to the cylinder.

16. A method for inspecting an object using a scanner system having a probe connected to an adjustable mount operably connected with an actuator configured to maintain the probe in a constant contact force with the object, the method comprising:
moving the probe along the object;
maintaining the probe in a constant contact force with the object;
generating a signal representative of a position of the probe on the object;
emitting a pulse into the object; and
receiving a pulse reflected from the object.

17. The method of claim 16, further comprising pneumatically maintaining the probe in a constant contact force with the object.

18. A non-transitory computer-readable medium having stored thereon computer-readable instructions which when executed cause the computer to perform a method for inspecting an object using a scanner system having a probe connected to an adjustable mount operably connected with an actuator configured to maintain the probe in a constant contact force with the object, the method comprising:
moving the probe along the object;
maintaining the probe in a constant contact force with the object;
generating a signal representative of a position of the probe on the object;
emitting a pulse into the object; and
receiving a pulse reflected from the object.
